(19) United States
(12) Patent Application Publication
(10) Pub. No.: US 2017/0025696 A1
(43) Pub. Date: Jan. 26, 2017

(54) FUEL CELL SYSTEM WITH IMPROVED THERMAL MANAGEMENT

(71) Applicant: LG Fuel Cell Systems Inc., North Canton, OH (US)

(72) Inventors: Michele Bozzolo, Derby (GB); Gary J. Saunders, Derby (GB); Gerard D. Agnew, Uttoxeter (GB); Robert Cunningham, Derby (GB)

(21) Appl. No.: 15/302,236

(22) PCT Filed: Apr. 9, 2015
(86) PCT No.: PCT/GB2015/051088

§ 371 Date: Oct. 6, 2016

(30) Foreign Application Priority Data
Apr. 10, 2014 (GB) 1406449.7

(51) Int. Cl. H01M 8/0637; H01M 8/04089; H01M 8/04111; H01M 8/04014

(52) U.S. Cl. CPC H01M 8/0637; H01M 8/04022; H01M 8/04097; H01M 8/04111; H01M 2008/1293

(57) ABSTRACT

There is disclosed a high temperature fuel cell system incorporating off-gas anode loop recycling and reforming. The fuel cell system includes a fuel cell stack having an anode inlet for fuel and an anode outlet for off-gas. A recycling device is configured to receive at least a portion of the off-gas from the anode outlet and to mix the portion of the off-gas with hydrocarbon fuel from a primary hydrocarbon fuel stream so as to form a reformable mixture. A reformer is configured to receive the reformable mixture from the recycling device and to generate a reformed fuel stream by reforming the reformable mixture. The fuel cell system is provided with a secondary hydrocarbon fuel stream and the reformed fuel stream and the secondary hydrocarbon fuel stream are supplied to the anode inlet of the fuel cell stack.

### FIELD OF INVENTION

The present invention relates to a fuel cell system with improved thermal management. In particularly, the invention relates to high temperature fuel cell systems incorporating off-gas anode loop recycling and reforming.

### BACKGROUND

A fuel cell is an electrochemical conversion device that produces electricity directly from oxidizing a fuel.

High-temperature fuel cell systems including solid oxide fuel cells (SOFCs) and molten carbonate fuel cells (MCFCs) operate at very high temperatures and may run directly on practical hydrocarbons without the need for complex and expensive external fuel reformers necessary in low-temperature fuel cells. Some high-temperature fuel cells may operate at high enough temperatures that fuel may be reformed internally within the fuel cells. The invention will be described with reference to solid oxide fuel cells but it will be appreciated that the invention is applicable to any high-temperature fuel cell technology relying on internal reforming.

A SOFC has an anode loop and a cathode loop, the anode loop being supplied with a stream of fuel (typically methane), and the cathode loop being supplied with a stream of oxidant (typically air). SOFCs operate at relatively high temperatures, typically around 1000° C. to maintain low internal electrical resistances. It is a challenge to maintain such high temperatures, and a further challenge to reduce the temperature gradient across a plurality of fuel cells such as a fuel cell stack.

One useful way of managing fuel cell stack temperature gradients is via internal fuel reforming.

If a solid oxide fuel cell system is powered by a hydrogen-rich, conventional fuel, such as natural gas, methane, methanol, gasoline, diesel, or gasified coal, a reformer is typically used to convert hydrocarbons into a gas mixture of hydrogen and carbon compounds called “reformate”.

Solid oxide fuel cells operate at temperatures high enough that the fuel can be reformed in the fuel cell itself. This type of reforming is called internal reforming. Fuel cells that use internal reforming still need methods to remove impurities from the unreformed fuel before it reaches the fuel cell, otherwise carbon deposits may occur within the fuel cell causing degradation of the fuel cell. Internal reforming on nickel cermet anodes in solid oxide fuel cells tends to catalyse carbon formation.

Internal steam reforming simplifies the balance of a solid oxide fuel cell stack and improves operating efficiency. However, reforming a hydrocarbon fuel within the solid oxide fuel cell stack has a number of problems which have not hitherto been overcome. Full internal reforming of the hydrocarbon fuel in a solid oxide fuel cell stack is precluded by the strongly endothermic nature of the steam reforming reaction, and consequential thermal shocking of the delicate fuel cells.

Thermal management of the fuel cell stack is important for balancing fuel cell performance and fuel cell life span. Typically, the fuel cell stack runs cold at the front, near the oxidant inlet, of the stack, and hotter at the back, near the oxidant outlet, of the stack. The temperature gradient is due to inefficiencies in the fuel cells arising from energy losses given off as Ohmic heat. Consequently, each fuel cell strip within the stack causes an additional temperature rise.

When the fuel cell stack runs hot, the performance of the fuel cell stack is good but the life of the fuel cells reduces through increased degradation of the fuel cells. When the stack runs cold, the performance of the stack is poor, but the life of the fuel cells increases. There is a balance between fuel cell stack performance and fuel cell stack life and there is therefore an optimum temperature range over which the fuel cell stack would ideally be operated.

Embodiments of the present invention aim to mitigate some of the problems above by improving thermal management of the fuel cell stack.

US2007/065687A1 discloses a solid oxide fuel cell stack comprising a catalytic partial oxidation (CPOx) reformer arranged to supply reformate to the fuel cell stack. A portion of the anode off-gas is recycled directly into the anode inlet of the fuel cell stack, such that the fuel reaching the anodes is a mixture of fresh reformate and recycled anode off-gas, and is present at a sufficiently high temperature that endothermic reforming of residual hydrocarbons from the CPOx reformer occurs within the fuel cell stack. The anode off-gas is hot, at the stack temperature of 750-800° C., which allows for the mixture of anode off-gas and secondary reformate fuel to be mixed and reacted in a clean-up catalyst to reform higher hydrocarbons in the secondary reformate fuel, without additional oxygen, prior to being mixed with reformate and sent to the fuel cell stack.

As a result of the reforming reaction being endothermic, a small fraction of the reforming heat input is subtracted from the fuel cell stack, assisting with thermal management of the fuel cell stack.

### SUMMARY OF THE DISCLOSURE

According to a first aspect, there is provided a high-temperature fuel cell system comprising:

a fuel cell stack having an anode inlet for fuel and an anode outlet for off-gas;

a recycling device configured to receive at least a portion of the off-gas from the anode outlet and to mix the portion of the off-gas with hydrocarbon fuel from a primary hydrocarbon fuel stream so as to form a reformable mixture;

a reformer configured to receive the reformable mixture from the recycling device and to generate a reformed fuel stream by reforming the reformable mixture; and

a secondary hydrocarbon fuel stream;

wherein the reformed fuel stream and the secondary hydrocarbon fuel stream are supplied to the anode inlet of the fuel cell stack.

The benefit of providing a secondary hydrocarbon fuel stream in addition to the reformed fuel stream to the anode inlet is that a larger proportion of hydrocarbon fuel will reform within the fuel cell stack because the secondary hydrocarbon fuel is unreformed at the anode inlet. Thus, the secondary hydrocarbon fuel stream endothermically reacts within the fuel cell stack. The endothermic reaction helps to cool the stack, and improves management of the temperature gradient though the fuel cell stack.

Fuel cell stacks typically consist of a plurality of smaller fuel cell sub units connected in series and/or in parallel. During operation, the stack generally exhibits a temperature gradient across the fuel cell stack. The fuel cell strips at the front of the fuel cell stack run at a cooler than ideal temperature and the fuel cell strips at the back of the fuel cell stack run at a hotter than ideal temperature. This is due to inefficiencies within the fuel cell strips. All electrochemical reactions are somewhat inefficient and losses in the fuel cells manifest as heat, due to the internal resistance of the fuel cells. Although heat is taken up in part by an air stream surrounding the fuel cells, a temperature gradient between consecutive fuel cell strips is still experienced within the fuel cell stack.

By providing reformed fuel and a secondary hydrocarbon fuel stream directly to the fuel cell stack anode inlet, further fuel reforming can take place within the fuel cell stack. The endothermic reforming reaction thus absorbs more heat within the fuel cell stack, thereby cooling the fuel cell stack and managing the temperature gradient throughout the fuel cell stack.

The effect of the endothermic reforming reaction is larger in the first fuel cells within the fuel cell sub unit. However, mass transfer limits within the fuel cell stack materials and counter-diffusion of reaction products can result in the endothermic reforming reaction extending through a significant portion of the stack and not simply confined to the anode inlet.

Optionally, the reformed fuel stream is combined with the secondary hydrocarbon fuel stream downstream of the reformer, and supplied to the anode inlet.

Optionally, a recycle flow rate of the portion of off-gas is proportional to a flow rate of the primary hydrocarbon fuel stream.

When the recycle flow rate (i.e. off-gas flow rate) is proportional to the primary hydrocarbon fuel stream flow rate, a smaller proportion of off-gas flow is recycled to the anode inlet of the fuel cell stack, resulting in higher partial pressures of hydrogen and carbon monoxide within the fuel cell stack and therefore improved fuel availability within the fuel cell stack.

The ratio of recycle flow rate to flow rate of the primary hydrocarbon fuel stream is important for converting the primary hydrocarbon fuel stream into synthetic gas (i.e. hydrogen and carbon monoxide). Off-gas includes a portion of steam as well as other exhaust products. If the recycle ratio (i.e. off-gas to primary hydrocarbon fuel stream) is too low then detrimental reactions such as carbon formation can take place on the components of the fuel cell system such as the catalyst reactor, steam reformer, pipework or fuel cells. However, if the recycle ratio is too high, then too much carbon dioxide is generated in the system which is detrimental to the fuel cell stack performance.

Optionally, the range of the ratio of secondary hydrocarbon fuel stream to reformed fuel stream may be from approximately 1:5 and approximately 1:60.

Optionally, the optimum recycle ratio may be between 5:1 and 6:1 of off-gas to primary hydrocarbon fuel stream.

Optionally, a recycle ratio from about 3:1 to about 10:1 may provide a steam to primary hydrocarbon fuel stream ratio of between 2:1 to 3:1. The recycle ratio is the ratio of the flow rate of the portion of off-gas to the flow rate of primary hydrocarbon fuel stream.

Optionally, the reformer may be a catalytic reformer.

Optionally, the catalyst of the catalytic reformer may be a steam reforming catalyst.

Optionally, a cathode outlet of the fuel cell stack may be arranged to supply hot air from the fuel cell stack to the reformer.

The ratio of the secondary hydrocarbon fuel stream to the reformed hydrocarbon fuel stream may be selected to achieve a desired temperature within the fuel cell stack.

According to a second aspect, there is provided a method for operating a high-temperature fuel cell system comprising a fuel cell stack having an anode inlet for fuel and an anode outlet for off-gas, a recycling device and a reformer; wherein:

at least a portion of the off-gas from the anode outlet is supplied to the recycling device and the portion of the off-gas is mixed with hydrocarbon fuel from a primary hydrocarbon fuel stream so as to form a reformable mixture;

the reformable mixture from the recycling device is supplied to the reformer, the reformable mixture being reformed in the reformer into reformed fuel;

the reformed fuel is combined with additional hydrocarbon fuel downstream of the reformer; and

the combined reformed fuel and additional hydrocarbon fuel is supplied to the anode inlet of the fuel cell stack.

### BRIEF DESCRIPTION OF THE DRAWINGS

Embodiments of the invention are further described hereinafter with reference to the accompanying drawings, in which:

FIG. 1 shows a high-temperature fuel cell system.

### DETAILED DESCRIPTION

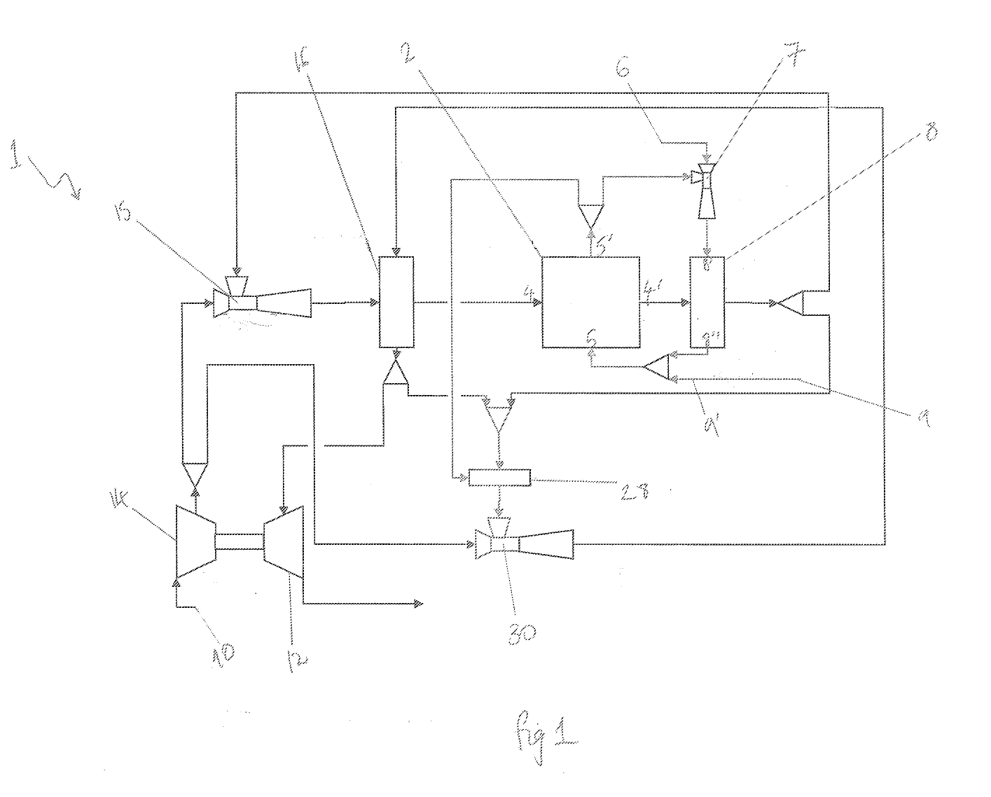

FIG. 1 shows an example of one embodiment of a high-temperature fuel cell system 1 comprising a fuel cell stack 2, a fuel recycling device 7, a stack anode inlet 5, a stack anode outlet 5′ and a reformer 8. The fuel cell stack 2 also has a cathode inlet 4 and a cathode outlet 4′. The anode outlet 5′ is arranged to supply a first portion of off-gas from the fuel cell stack 2 to the fuel recycling device 7. The fuel recycling device 7 combines the first portion of off-gas with a primary hydrocarbon fuel stream 6 to form a reformable mixture. The fuel recycling device 7 supplies the reformable mixture to the reformer inlet 8′ of the reformer 8. The reformer 8 has a reformer outlet 8′ for reformed fuel.

An additional hydrocarbon fuel stream 9, i.e. a secondary hydrocarbon fuel stream and the reformed fuel stream are supplied to the anode inlet 5 of the fuel cell stack 2.

In a specific embodiment, the secondary hydrocarbon fuel stream 9 and the reformed fuel stream are combined downstream of the reformer 8, and supplied to the anode inlet 5. A second port 9′ arranged between the reformer outlet 8″ and the anode inlet 5 provides an additional hydrocarbon fuel stream i.e. a secondary hydrocarbon fuel stream. The secondary hydrocarbon fuel stream 9 combines with the reformed fuel and the combined secondary hydrocarbon fuel stream 9 and reformed fuel supply the anode inlet 5.

In an alternative embodiment, the second port 9′ may supply the anode inlet 5 directly, so that the secondary fuel stream and the reformed fuel stream mix within the fuel cell stack 2.

The high-temperature fuel cell system 1 may also include a gas turbine comprising a compressor 14 and a turbine 12. The fuel cell stack 2 includes at least one fuel cell, having an electrolyte, an anode and a cathode. The compressor 14 is arranged to supply at least a portion of the oxidant 10 to the cathode of the at least one solid oxide fuel cell of the fuel cell stack 2 at the cathode inlet 4, the primary hydrocarbon fuel stream 6 is arranged to supply fuel to the anode inlet 5 of the at least one solid oxide fuel cell of the fuel cell stack 2. The fuel cell stack 2 is arranged to supply a first portion of the unused oxidant from the cathode outlet 4′ of the at least one fuel cell of the fuel cell stack 2 to the reformer 8, and the reformer 8 supplies a portion of the unused oxidant to an ejector 30. The fuel cell stack 2 supplies a first portion of the off-gas (unused fuel) from the anode outlet 5′ to the fuel recycling device 7.

The fuel recycling device 7 combines the portion of off-gas with the primary hydrocarbon fuel stream 6 to form a reformable mixture, and the fuel recycling device 7 supplies the reformable mixture to the reformer 8. The reformer has a reformer inlet 8′ and a reformer outlet 8″ for reformed fuel.

The optimum recycle ratio is between 5:1 and 6:1 of off-gas to primary hydrocarbon fuel stream.

A recycle ratio between 3:1 to 10:1 provides a steam to primary hydrocarbon fuel stream ratio of between 2:1 to 3:1. The recycle ratio is the ratio of the flow rate of the portion of off-gas to the flow rate of primary hydrocarbon fuel stream.

A combustor 28 is provided to combust the first portion of the off-gas with unused oxidant from the reformer 8. The ejector 30 entrains the combustion products from the combustor 28 and supplies the combustion products to a heat exchanger 16. The heat exchanger 16 heats a portion of the oxidant (i.e. air) prior to it entering the fuel cell stack 2. The heat exchanger 16 prevents harmful combustion products such as steam from entering the fuel cell stack 2.

A portion of the oxidant 10 is supplied from the compressor 14 to an ejector 15 and a second portion of unused oxidant from the fuel cell stack 2 which has passed through the reformer 8 is supplied to the ejector 15. The ejector 15 mixes the oxidant supplied by the compressor 14 and the unused oxidant from the fuel cell stack 2 which has passed through the reformer 8 and supplies the mixture of oxidant and unused oxidant through the heat exchanger 16 to the cathode inlet 4 of the fuel cell stack 2.

A second portion of the oxidant 10 is supplied from the compressor 14 to the ejector 30 to entrain the combustion products from the combustor 28. The combustion products are recycled via the ejector 30 to the heat exchanger 16. A first portion of the combustion products is supplied from the heat exchanger 16, after heating the oxidant supplied from the ejector 15 to the oxidant inlet 4 of the fuel cell stack 2, to the turbine 12 of the gas turbine and the turbine 12 is arranged to drive the compressor 14 via a shaft 13. An electrical generator 32 is also driven by the turbine 12. A second portion of the combustion products is supplied from the heat exchanger 16 to the combustor 28.

In certain embodiments, it is possible to arrange for all of the combustion products to be supplied from the heat exchanger 16 to the turbine 12.

The ratio of secondary hydrocarbon fuel stream to reformed fuel stream is selected to provide optimal additional reforming within the fuel cell stack. Providing too higher ratio of secondary hydrocarbon fuel stream to reformed fuel stream results in a loss in fuel efficiency because the temperature fuel cell would drop below ideal operating temperatures. Providing too low a ratio of secondary hydrocarbon fuel stream to reformed fuel stream reduces the effect of the reforming reaction within the fuel cell stack and reduces the effect of the secondary hydrocarbon fuel stream.

The ratio of the secondary hydrocarbon fuel stream to the reformed hydrocarbon fuel stream is selected to achieve a desired temperature within the fuel cell stack.

The benefit of the second port 9′ providing a secondary hydrocarbon fuel stream 9 downstream of the reformer 8 is that a larger proportion of fuel relative to reformed fuel reforms within the fuel cell stack 2, thereby reacting endothermically and cooling the fuel cell stack 2 and improving the management of the temperature gradient though the fuel cell stack 2.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A high-temperature fuel cell system comprising:
a fuel cell stack having an anode inlet for fuel and an anode outlet for off-gas;
a recycling device configured to receive at least a portion of the off-gas from the anode outlet and to mix the portion of the off-gas with hydrocarbon fuel from a primary hydrocarbon fuel stream so as to form a reformable mixture;
a reformer configured to receive the reformable mixture from the recycling device and to generate a reformed fuel stream by reforming the reformable mixture; and
a secondary hydrocarbon fuel stream;
wherein the reformed fuel stream and the secondary hydrocarbon fuel stream are supplied to the anode inlet of the fuel cell stack.

2. A high-temperature fuel cell system as claimed in claim 1, wherein the reformed fuel stream and the secondary hydrocarbon fuel stream are supplied to the anode inlet indirectly.

3. A high-temperature fuel cell system as claimed in claim 2, wherein the reformed fuel stream and the secondary hydrocarbon fuel stream are combined via mixing means, down-stream of the reformer.

4. A high-temperature fuel cell system as claimed in claim 1, wherein the ratio of the secondary hydrocarbon fuel stream to the reformed fuel stream is from approximately 1:5 to approximately 1:60.

5. A high-temperature fuel cell system as claimed in claim 1, wherein the flow rate of the portion of off-gas is proportional to the flow rate of primary hydrocarbon fuel stream.

6. A high-temperature fuel cell system as claimed in claim 1, wherein the ratio of the flow rate of the portion of off-gas to the flow rate of primary hydrocarbon fuel stream ranges from about 5:1 to about 6:1.

7. A high-temperature fuel cell system as claimed in claim 1, wherein a recycle ratio between about 3:1 to about 10:1 provides a steam to primary hydrocarbon fuel stream ratio of between about 2:1 to about 3:1.

8. A high-temperature fuel cell system as claimed in claim 1, wherein the reformer is a catalytic reformer.

9. A high-temperature fuel cell system as claimed in claim 8, wherein a catalyst of the catalytic reformer comprises a steam reforming catalyst.

10. A high-temperature fuel cell system as claimed in claim 1, wherein the fuel cell stack comprises a cathode outlet of the fuel cell stack, the cathode outlet being arranged to supply hot air from the fuel cell stack to the reformer.

11. A high temperature fuel cell system as claimed in claim 1 wherein the high-temperature fuel cell system is a solid oxide fuel cell system.

12. A method for operating a high-temperature fuel cell system comprising a fuel cell stack having an anode inlet for fuel and an anode outlet for off-gas, a recycling device and a reformer; wherein:
at least a portion of the off-gas from the anode outlet is supplied to the recycling device and the portion of the off-gas is mixed with hydrocarbon fuel from a primary hydrocarbon fuel stream so as to form a reformable mixture;
the reformable mixture from the recycling device is supplied to the reformer, the reformable mixture being reformed in the reformer into reformed fuel;
the reformed fuel is combined with additional hydrocarbon fuel downstream of the reformer; and
the combined reformed fuel and additional hydrocarbon fuel is supplied to the anode inlet of the fuel cell stack.
